(19) United States
(12) Patent Application Publication
(10) Pub. No.: US 2017/0183035 A1
(43) Pub. Date: Jun. 29, 2017

(54) DYNAMIC LANE SHIFT

(71) Applicant: Microsoft Technology Licensing, LLC, Redmond, WA (US)

(72) Inventor: Tero Patana, Lynnwood, WA (US)

(21) Appl. No.: 14/982,498

(22) Filed: Dec. 29, 2015

(51) Int. Cl. B62D 15/02; G05D 1/02

(52) U.S. Cl. CPC B62D 15/025; G05D 1/0214

(57) ABSTRACT

A machine-implemented method is provided for controlling a fully automated or partially automated road vehicle so as to accurately position the vehicle within a traffic lane occupied by the vehicle. The method includes: determining locations of or distances to side boundaries or a longitudinal center of a traffic lane currently occupied by the vehicle; determining a currently requested or commanded offset from either one of the side boundaries or the longitudinal center of the traffic lane; determining if the vehicle is currently at least substantially complying with the requested or commanded offset; and if the vehicle is not currently substantially complying with the offset, adjusting a steering control of the vehicle to thereby bring the vehicle into compliance with the currently requested or commanded offset. By requesting or commanding different offsets on different days, road wear is more evenly distributed and concentrate break down due to accurate lane centering is avoided.

### BACKGROUND

Increasingly, vehicle control is evolving from a substantially all-manual control paradigm to a predominantly automated scheme. This includes a transition from driver controlled positioning of a vehicle within roadway space to a driverless and substantially all automatic control of positioning.

### SUMMARY

Partial and fully automated vehicle control with respect to positioning of a vehicle within a roadway space may result in precise aligning of every automated vehicle with the centerline of its respectively occupied traffic lane. Such precise alignment may over time result in concentrated wear and tear along the lane bands occupied by vehicles having common and standardized wheelbase dimensions. As a result of the concentrated loads and shocks, those more frequently ridden in lane bands will tend to become ruts and/or break down and require repair significantly sooner than if load was distributed in a less concentrated manner onto lane bands other than the ones centering with the center of the lane and corresponding to the more common and standardized wheelbase dimensions.

In accordance with one aspect of the present disclosure, road vehicles are urged or caused to use lane bands other than the ones centering with the center of the lane and corresponding to common and standardized wheelbase dimensions. Such use of alternate lane bands is referred to here as lane shift.

In accordance with a further aspect of the present disclosure, the amount of lane shift off of the lane center (hereafter also lane offset) may be dynamically varied as a function of one or more parameters including but not limited to time and/or date, traffic density, traffic speed, vehicle types (e.g., vehicle weight, length, width, stability, degree of automation), presence of nearby vehicles not complying with an assigned lane offset, weather conditions, communications reliability, navigation reliability and type of roadway construction present in the road segment where lane offset is being implemented. Other aspects of the present disclosure will become apparent in the below Detailed Description.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a perspective view of a traffic occupied roadway, associated structures and associated environmental factors.

FIG. 1B is a perspective view with schematic additions of a road occupying vehicle, the occupied road, associated other structures and associated environmental factors.

FIG. 2 is a flow chart of a routine for entering into an automated lane offset mode.

FIG. 3 is a flow chart of a routine for maintaining an automated lane offset mode.

FIG. 4 is a schematic view of a driver interface including a lane align mode indicator and selector for switching in and out of a lane shift complying mode.

FIG. 5 is a block diagram of one embodiment of hardware and software components of a in vehicle system as may be used with one or more embodiments.

### DETAILED DESCRIPTION

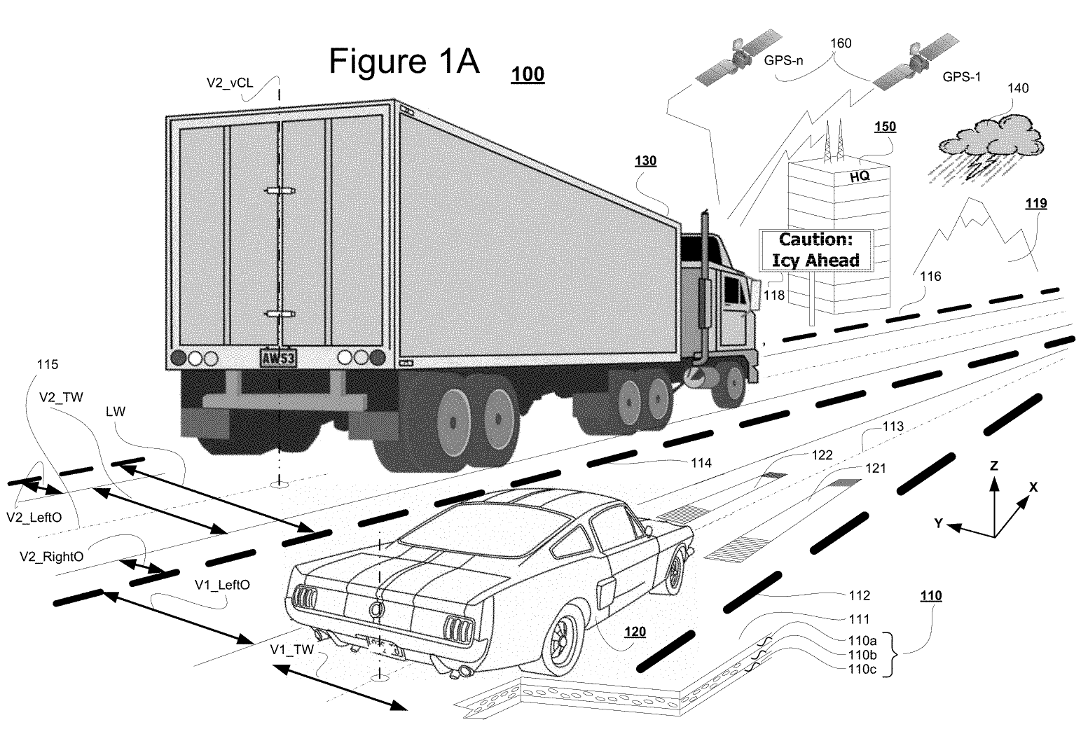

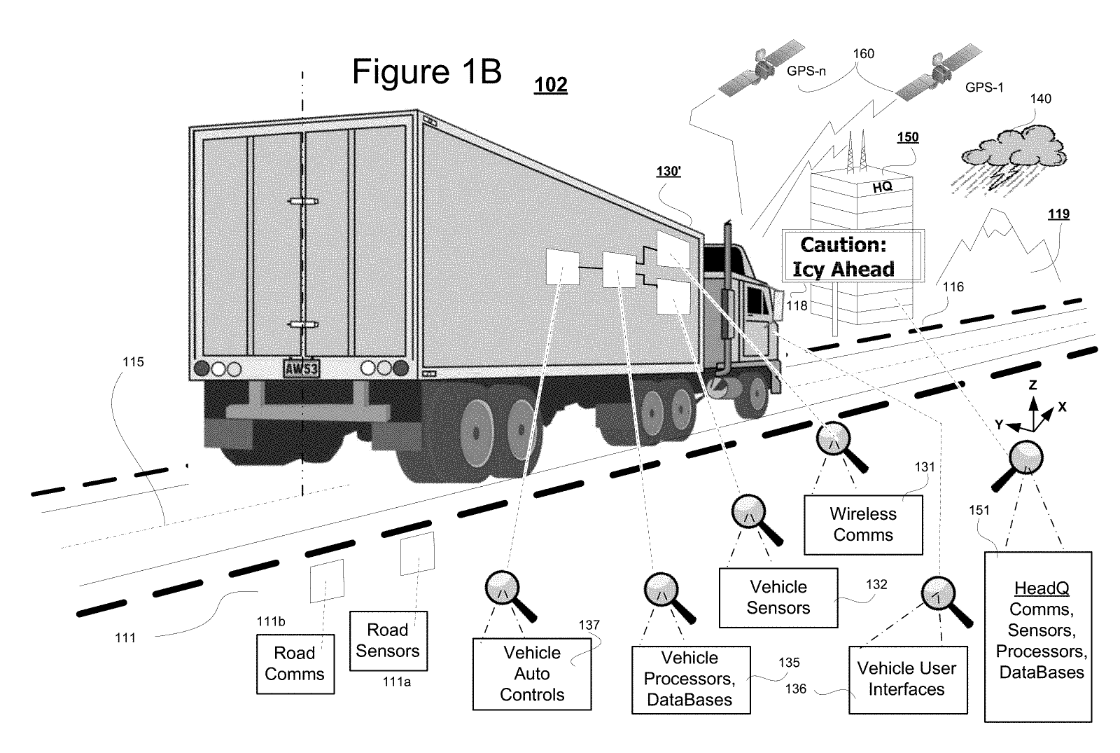

FIG. 1A is a perspective view of an environment 100 that includes a traffic occupied roadway 110, a first vehicle 120 occupying a portion of the roadway, a second vehicle 130 occupying another portion of the roadway, associated road-side structures (e.g., electronic sign 118), associated off-road structures (e.g., headquarters building 150), associated navigation aids (e.g., GPS satellites 160, lane stripes 112, 114, 116) and associated environmental factors (e.g., changing road topography 119 and upcoming storms 140).

Referring to the roadway 110, it may include an optional right side shoulder portion 111, a right side lane stripe 112 for its rightmost lane, a left side lane stripe 114 for its rightmost lane (which stripe 114 may also serve as the right side lane stripe for the second from right lane) and a left side lane stripe 116 for the second lane. In the illustrated example, the first vehicle 120 occupies and is centered on the first lane (centered between stripes 112 and 114) while the second vehicle 130 occupies and is centered on the second lane (centered between stripes 114 and 116). Although a two lane roadway 110 is depicted for illustrative purposes, it is within the contemplation of the present disclosure to have only one lane or only one lane per driving direction or two have roadways with more lanes, including for example, exit only and/or entrance only lanes, service lanes, emergency vehicle lanes, passing lanes and so forth.

Road vehicles such as 120 and 130 are typically mass-produced and therefore have respective standardized characteristics including normal vehicle weights, normal vehicle tread widths per tire (not referenced, but corresponding to the widths of the illustrated lane bands 121, 122), normal left tire to right tire width dimensions (e.g., V2_TW, V1_TW), normal vehicle lengths (not referenced), number of axles, vehicle heights, automated control capabilities and so forth.

The roadway itself 110 may have various characteristics along respective segments thereof (e.g., mile long stretches). The various roadway segment characteristics may include the respective width (LW) of each lane, the presence or absence of a right side shoulder 111, the presence or absence of a left side shoulder (not shown), the types and materials of the right side and left side shoulders and the types and materials of the respective lanes. For example, each lane may have a top textured layer 110a made of a relatively soft material such as asphalt or of a relatively hard material such as concrete, an intermediate layer 110b supporting the top layer 110a and providing various subsurface functions including for example shock absorption and water drainage and a lower layer 110c supporting the intermediate layer and providing yet other subsurface functions including interfacing with the underlying natural terrain.

Various roadside structures may be provided along the left and/or right sides of the roadway such as guardrails, mileage markers, emergency telephone posts, entrance and exit ramps, non-changing traffic guidance signs such as those warning of speed limits and curves ahead and changing traffic guidance signs such as electronically controlled signs. One such electronically controlled sign is depicted at 118 as cautioning drivers that there are icy conditions up ahead. The electronically controlled signs (only one shown at 118) may be controlled by remote control centers such as an off-road headquarters building 150 (HQ). In one embodiment, one of the remote control centers (e.g., 150) may cause electronically controlled sign 118 to indicate a suggested lane offset amount and direction for the given day or other unit of time and/or to indicate that automated lane offset should be turned off due to counter-indicative conditions. The remote control centers (e.g., 150) may be operatively coupled to various information providing sources including those reporting or predicting weather conditions, those reporting or predicting traffic density, speed and accident conditions, those reporting or predicting communication outage and reliability-altering conditions, and so forth.

Although not specifically shown in FIG. 1A, the lane delimiting stripes 112, 114, 116 may be of various kinds including those with or without reflectors, those with or without different colors, those with or without crossover warning bumps, those with or without embedded electronic or magnetic transducers and those with or without various traffic guiding patterns including patterns warning against lane change, indicating an exit-only lane or indicating a merging traffic lane.

While steering of vehicles is predominantly under manual driver control in current vehicles (e.g., an exception being automated parking) it is expected that in the near future steering of vehicles will become more and more automated until ultimately drivers or passengers will be denied almost all control over steering except in cases of emergency (e.g., failure or questionable reliability of the automated steering system). However, once full automation or partial automation of steering control becomes common in various types of vehicles including large sized tractor-trailers (e.g., those carrying heavy loads such as 10 tones or more) and smaller sized passenger vehicles (e.g., buses, vans and smaller four—six passenger vehicles i.e., cars) it will be possible to control positioning of such vehicles within the roadway space so as to precisely align every automated vehicle with the centerline (e.g., V2_CL) of its respectively occupied traffic lane (e.g., between lanes 114/116). Such precise alignment may over time result in concentrated wear and tear along the lane bands (e.g., 121, 122) occupied by the more common and standardized wheelbase dimensions (e.g., V1_TW) of the lane occupying vehicles. As a result of the concentrated loads and shocks, those lane bands (e.g., 121,122) will tend to break down and require repair or replacement significantly sooner than if load was distributed in a less concentrated manner onto lane bands other than the ones (121, 122) centering with the center of the lane and corresponding to the more common and standardized wheelbase dimensions (e.g., V1_TW).

In accordance with one aspect of the present disclosure, road vehicles (e.g., 120, 130) are urged (e.g., by road signage 118) or caused (e.g., by automated means) to use lane bands other than the ones (e.g., 121, 122) centering with the center of the lane and corresponding to the more common and standardized wheelbase dimensions (e.g., V1_TW). Such use of alternate lane bands is referred to here as lane shift. An exemplary case of lane shift occurs in FIG. 1A when the left side offset V2_LeftO between wheel base (V2_TW) and the left side lane delimiter 116 is not equal to the right side offset V2_RightO between wheel base (V2_TW) and the right side lane delimiter 114. The amount and direction of lane shift may be dynamically altered and may be made a function of one or more parameters including but not limited to time and/or date, traffic density, traffic speed, accident situations, vehicle types (e.g., vehicle weight, length, width, stability, degree of automation), weather conditions, communications reliability, navigation reliability, presence of nearby but non-compliant vehicles and type of roadway construction present in the road segment where lane offset is being implemented.

The direction and amount of lane offset away from the lane center mark (e.g., 113 which is midway between 112 and 114) may be established by a remote control center such as HQ 150 where the remote control center is owned by and/or operated on behalf of a roadway control entity having maintenance jurisdiction over the respective roadway 110 and or a specific lane (e.g., 112/114) of that roadway. Examples of roadway control entities include various government and/or private agencies who are charged with maintaining and repairing roadways within respective geographic areas such as states, counties, cities and townships. It is within the contemplation of the present disclosure that roadway control entities may also include private enterprise ones who build and/or maintain special use lanes such as high speed and high vehicle occupancy lanes for which tolls are charged (e.g., by means of wireless toll charging devices). Each such roadway control entity will typically have a financial interest in causing traffic in respective segments of its controlled roadway to shift over from lane center so as to distribute shock, wear and tear applied to different lane bands (e.g., 121, 122) based on one or more factors so as to thereby increase the longevity of the road and/or reduce cost of maintenance, reduce time for maintenance and/or increase durations between maintenance road closures; thereby providing benefits both to the roadway control entity and the populace that uses the respective roadway or specialty lane. It is to be understood that the term roadway as used herein is not limited to ground level roadways and may additionally include bridges, elevated highways, underground passageways and other such structures.

Each such traffic-bearing structure may have its own unique characteristics with respect to preferred amounts and directions of per-lane lane shift based on time of day, temperature and or other weather conditions, traffic density, traffic type and loads (e.g., tractor-trailer gross weights), traffic speed, current communication capabilities, number of lane shift noncompliant vehicles and so forth. The preferred amounts and directions of per-lane lane shift for each segment of roadway and for the respective determinative parameters may be stored in one or more databases of a respective one or more control centers and may be communicated to respective the vehicles by way of one or more location-available communication means including, but not limited to: road side signage 118; radio broadcasts or multicasts from the control centers (e.g., HQ 150); radio and/or other wireless communications from roadside transponders and/or from in-vehicle transponders configured for providing vehicle-to-vehicle communications; and/or from communication satellites. The control centers need not all be stationary ones. In one embodiment, mobile control centers patrol respective stretches of roadways under their jurisdiction, collect roadway and traffic condition data by way of onboard sensors, store that data into on-board in databases or remote databases and use the database information in combination with appropriate lane-shift determining algorithms to establish desired amounts of per-lane lane offset given the extant conditions.

One of the many possible lane-shift determining algorithms may output requests to all traffic of a given roadway (e.g., 110) to shift off center to the right by 10 inches on Mondays, 10 inches off center to the left on Tuesdays and drive with no offset (in the lane centers) on Wednesdays. The same machine-implemented and database driven algorithm may output requests to all traffic on Thursdays to shift left by 15 inches and on Fridays to shift right by 8 inches. In this way, the cross-road (Y-direction) spacing between neighboring vehicles of adjacent lanes is kept the same so that safety is maintained and at the same time the applied loads are temporally distributed over different lane bands (e.g., 121, 122) so that no one or more lane-centered set of bands receives a super majority of the traffic load and is thus worn out while other lane bands remain substantially unused.

By way of example, another of the possible lane-shift determining algorithms may ask traffic in the left most lane to shift left by 12 inches while traffic in a center and adjacent rightmost lane are asked to shift right by 8 inches. In this case the cross-road (Y-direction) spacing between neighboring vehicles in the left and center lanes is increased to more than the normal amount while the crossroad spacing between vehicles in the center and right lanes is kept at the normal amount. There may be a number of different reasons for why this exemplary lane-shift determining algorithm creates the wider safety margin in the cross-road Y-direction. One possibility is that the left-most lane is determined to be carrying traffic moving at the fastest speed. Another possibility is that the center lane is determined to be carrying vehicles larger than those in the leftmost lane (for example tractor-trailers in the center and low occupancy passenger vehicles in the left). An alternative lane-shift determining algorithm may ask traffic of both the left and center lanes to shift left by a predetermined or communicated offset amount while asking traffic in the right lane to shift right by a respective predetermined or communicated offset amount. The reason for the latter non-symmetrical lane shift might be because the right lane carries traffic moving at an unusually slow speed (e.g., due to an accident or backed up exit ramp up road) and thus a wider spacing is desirable at that time between the center and right lanes. The various road conditions that lead to different nonsymmetrical lane offsets may be reported by one or more of remote control centers patrolling the roadways, embedded roadside and in road sensors, and sensors embedded in user vehicles where the owners of the user vehicles have agreed to have such sensors carried by their vehicles and configured to report to the control centers (e.g., HQ150).

Yet another lane-shift determining algorithm may differentiate between different kinds of vehicles, for example, asking heavy tractor-trailers to shift left by 10 inches while more populous but lighter passenger vehicles are asked to shift left by only 5 inches. Various reasons can underpin such nonsymmetrical requests to different kinds of vehicles, including realizations that the different vehicles have different wheelbase dimensions and/or that different bands within a given lane should be sustaining greater or lesser weights due to different construction materials used for those different lane bands.

Yet another lane-shift determining algorithm may group clusters or rat packs of vehicles into respectively and differently controlled units. In some cases, vehicles bunch up on a highway or roadway into what may be described as rat packs, for example because they all clustered while waiting for a red light to turn green. In such a case, a lane shift-determining algorithm may provide different lane-shift and other traffic control requests/commands to each bunched up group of vehicles. More specifically, a first bunch may be requested to (or commanded to) perform a leftward lane offset while a spaced behind next bunch is requested/commanded to perform a rightward lane offset. The lane-shift determining algorithm may be part of an encompassing traffic control algorithm that not only specifies amount and direction of lane offset (e.g., in the Y direction of FIG. 1A) but also specifies longitudinal spacing (e.g., in the X direction of FIG. 0.1A) between the vehicles of each bunch and between successive bunches and optionally specifies average speeds for individual vehicles and/or for respective bunches of vehicles. In one embodiment, the traffic control algorithm may also specify the X direction ordering of vehicles within each bunch so that shorter vehicles (those having smaller dimensions in the Z direction of FIG. 1A) are at the front of the bunch and taller vehicles (e.g., tractor-trailers) are at the back of the bunch. This ordering of lane-shifted vehicles may be requested for a variety of reasons, including for the purpose of providing improved forward visibility for drivers/passengers of the vehicles. Similarly, alternate left/right lane shiftings for different bunches may be requested to/commanded for providing improved forward visibility at least for the pack-leading vehicles of the bunch.

Compliance with a requested or commanded lane shift algorithm may vary based on various extant conditions. Compliance need not be exact or constant over all time. In one class of embodiments, it is enough that there is substantial compliance. Such substantial compliance might allow for occasional drifts out of a specified ideal range of offsets for various reasons (e.g. temporary manual override to steer around a road hazard, the front end suspension hit a pothole and temporarily came out of strict compliance for a about a second or so, electrical noise temporarily interfered with navigation or sensing of road markers and so on). In one class of embodiments, the control center (e.g., HQ 150) may broadcast or multicast a definition of what constitutes substantial compliance where that definition can vary from road to road and/or under different weather conditions and/or from one kind of vehicle (e.g., tractor trailer) to another (e.g., small fully automated passenger car) and each vehicle determines based on the last received definition of what constitutes substantial compliance whether or not that particular vehicle is at least in substantial compliance (and better yet in strict compliance) given the vehicle type, the local weather condition, the currently occupied road type (e.g., top layer texture) and/or other appropriate parameters.

There can be a number of contributing factors for why owners and/or users of the vehicles volunteer to have their vehicles automatically cooperating with the lane-shift requesting system (e.g., one that operates signage such as 118 and/or radio broadcasts from corresponding control centers 150) and/or to have their vehicles equipped with roadway condition reporting devices. The roadway owners/operators may create various incentive programs whereby cooperating owners and/or users of vehicles receive discounts or gift cards for a variety of products and/or services including, for example, discounts or a limited number of free pass-throughs for tollbooths operated by the roadway owners/operators or affiliates. The tollbooths at which discounts or free pass-throughs are provided, need not be on the same of roadways where cooperation is provided. Alternatively, cooperation may be mandated by various governmental statutes or ordinances where lack of cooperation may result in a fine.

Referring to FIG. 1B, and instrumented environment 102 which allows for safe lane-shifting (and optionally other automated traffic control) will be described in more detail.

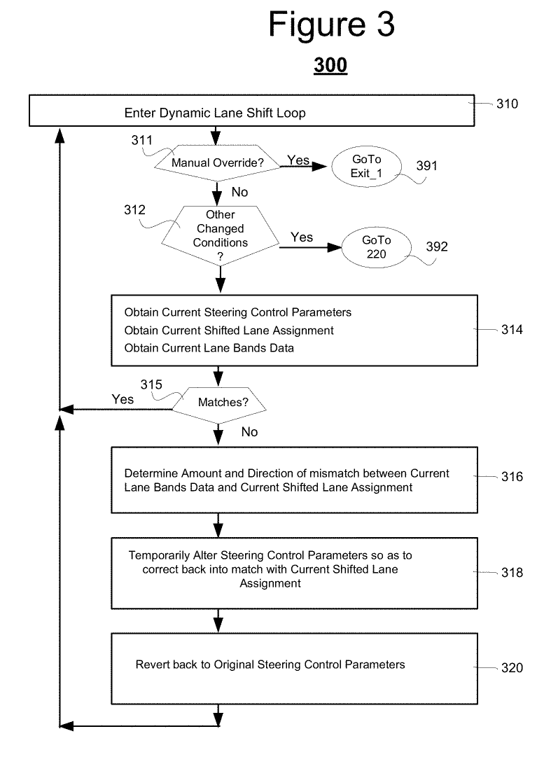

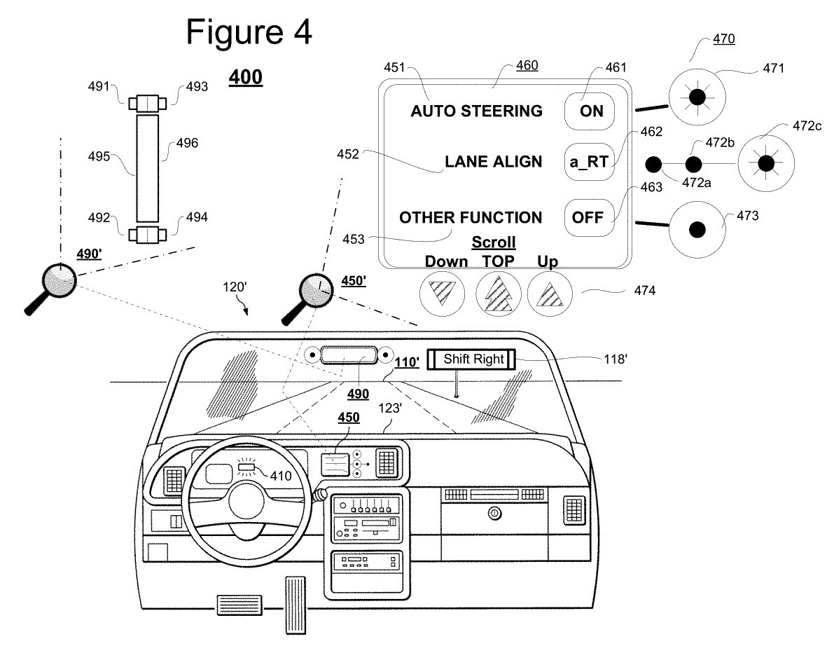

Instrumented vehicle 130′ of FIG. 1B will be taken as representative of other on road vehicles that are at least partially instrumented in a same way so as to enable safe implementation of automated lane-shifting (and optionally other automated traffic controls). In this regard, vehicle 130′ is equipped with one or more wireless communication subsystems 131, one or more on-vehicle sensor systems 132, one or more on-board data processing systems 135 (optionally including one or more on-board database servers), one or more on-board interfaces 136 for user to vehicle interactions, and a variety of vehicle behavior controllers 137 that can be controlled by automated means (e.g., by one or more of the onboard data processing systems 135) and/or through the user/vehicle interfaces 136 including a steering controller (not separately shown). Although not explicitly shown, it is to be understood that that the variety of vehicle behavior controllers 137 can include a variety of mechanical actuators including electrical and/or hydraulic motors, mechanical transmission units including those using gears or hydraulics; actuation sensors for assuring that commanded actuations have occurred and operation safety sensors for assuring that commanded actuations can be safely and automatically and repeatedly carried out. The steering controller (in 137) may be commanded by automated means to jog its commanded actuation of steered vehicle wheels so as to change their direction slightly to the left or slightly to the right so as to implement a desired amount of lane shift, for example in accordance with a machine implemented process depicted in FIG. 3. A driver/passenger interface such as shown in FIG. 4 (described below) is provided to warn respective vehicle users of when automated steering is turned on or off and to warn respective vehicle users of when automated lane alignment (e.g., shifted left/not/right) is turned on or off. In one embodiment, if a user grabs and overpowers the overridable steering wheel, both of automated steering and automated lane alignment are switched off and respective indicators activated to signal these mode changes.

The wireless communication subsystems 131 of the vehicle 130′ may include navigation receivers such as GPS receivers for acquiring navigation signals such as from in-line-of-sight GPS satellites 160 where the latter are used to automatically determine vehicle location, velocity and/or other navigation and timing data. The wireless communication subsystems 131 of the vehicle 130′ may alternatively or additionally include, vehicle to control center transceivers by way of which the vehicle can communicate with one or more local or remote control centers (e.g., HQ 150).

Additionally or alternatively the vehicle 130′ may include vehicle-to-vehicle transceivers by way of which the vehicle can communicate with one or more neighboring other vehicles (e.g., 120 of FIG. 1A). Vehicle-to-vehicle communications may include those where a first vehicle (e.g., 130′) warns neighboring others (e.g., 120) that the first vehicle is currently not in automated lane shift mode (and/or conversely affirming to the neighboring other vehicles that the first vehicle (e.g., 130′) is currently in automated lane shift mode and what the degree and direction of that lane offset is). Vehicle-to-vehicle communications may include those where the first vehicle (e.g., 130′) warns neighboring others (e.g., 120) that the first vehicle is currently detecting with its sensor systems 132 that an identified one or more of the neighboring others are not in compliance with the control center requested/commanded lane shift mode. In one embodiment, noncompliance by either the first vehicle (e.g., 130′) or one of the neighboring others (e.g., 120) may cause an automatic temporary switch by such neighboring vehicles into a fail-safe lane centering mode (zero lane offset). Once the basis for noncompliance is removed, the vehicles can negotiate among themselves and by way of the respective vehicle-to-vehicle communication resources when they will all simultaneously switch back into lane offset mode.

Additionally or alternatively the vehicle 130′ may include vehicle-to-road transceivers by way of which the vehicle can communicate with one or more adjacent to road or in-road transceivers 111b. The road-adjacent or inroad transceivers may enable the vehicle 130′ to link to further communication means including cable-connected networks (not shown) and/or to road-adjacent or in-road sensors 111a. The sensors 111a may provide various measurements and indications including, but not limited to, whether the given vehicle 130′ is aligned with a respective lane center (e.g., 115) or is offset from such a lane center and if so, by how much and in which direction. Among optional other measurements and indications provided by the sensors 111a are those measuring or indicating roadway conditions including, but not limited to: whether the roadway structure is breaking down and if so by how much; whether the top layer 110a of the roadway is wet or at a below freezing temperature or is covered by a hazardous material (e.g., oil spill) and if so, optionally what type of material.

The road sensors 111a may be configured to additionally or alternatively measure or indicate at least one of: traffic speed, traffic density, weight of the traffic passing over its respective segment, intensity of shocks delivered to the roadway, and so on. These measurements may be relayed directly to a roadway control center (e.g., HQ 150) or relayed indirectly (e.g., by way of vehicle 130′) to other neighboring vehicles and/or to a roadway control center. Database parameters for the corresponding segment of roadway may be automatically repeatedly updated based on measurements and indications collected from the roadway sensors 111a and/or collected from the vehicle sensors 132.

It is to be understood that wireless portions of vehicle communications 131 and/or road communications 111b may include a variety of different kinds of wireless technologies including, but not limited to: radiofrequency and microwave communications; optical communications (including in the IR portion of the spectrum); magnetically coupled communications (including by way of inductive couplers embedded in the roadway); ultrasonic communicators and so forth.

The vehicle sensors 132, like the road sensors 111a, may provide measurements and/or indications relevant to lane alignment, lane shift amount and direction; and parameters related to safety of entering into or maintaining an assigned lane shift mode. The vehicle sensors 132 may rely on electromagnetic transponders (not shown) embedded in the roadway at lane-associative positions such as lane centerlines (e.g., 115) and/or lane-delimiting stripes (e.g., 114, 116). The vehicle sensors 132 may rely on optical recognition of lane-delimiting stripes (e.g., 114, 116) and/or on the roadside or inroad location markers whose location indications may be combined with GPS or other navigation data acquired by the vehicle for thereby determining where, relative to the lane center (e.g., 115) the subject vehicle 130′ is positioned.

Others of the vehicle sensors 132 may provide sideways looking, forward-looking and/or backward looking distance indicating or measuring sensors for determining how far apart other vehicles (e.g., 120) are from the subject vehicle 130′. The distance indicating/measuring vehicle sensors may include ones based on radar technology, lidar technology and/or ultrasonic technology. One use of at least the sideways looking sensors is to assure that sideways separation (in the Y direction) between lane-adjacent vehicles is sufficient for minimizing risk of sideways collisions. A variety of risk avoidance measures may be automatically taken by on-board processors of one or more of the vehicles when it is sensed that sideways separation is less than a predetermined threshold. These can include reverting back to a lane centered alignment mode for all vehicles in the neighborhood; transmitting warning signals by way of vehicle-to-vehicle communications; adjusting the lane shift of at least one of the vehicles for thereby increasing sideways separation and generating of other warning signals including automatic sounding of vehicle horns. Although not explicitly shown, the vehicle sensors may rely on a variety of sensing technologies including, but not limited to, infrared (IR) illuminators and IR cameras and/or IR time-of-flight (TOF, LIDAR) illuminators determining sensors, acoustic emitters and detectors (e.g., ultrasonic), radar emitters and detectors, magnetic field generators and/or detectors, and so on. If a particular form of sensor or field generating device is not present on a first vehicle but is present on a neighboring vehicle in such manner that the first vehicle can request to actuate it and/or receive its signals, then appropriate wireless exchange protocols may be provided so that vehicles neighboring each other on the road may share their resources for mutual benefit. More specifically, one vehicle may have a currently non-operable IR illuminator while the vehicle next to it has a currently operable IR illuminator. The first vehicle may wirelessly and automatically request to the automated systems of the second vehicle that they turn on a road illuminating IR illuminator for thereby illuminating the roadway in front of both vehicle. Alternatively or additionally, if simultaneous actuation of field generators (e.g., IR emitters) may create interference between two or more neighboring vehicles, their automated systems may negotiate with appropriate protocols that one or more of the vehicles turn off their interfering field generators (or alternate time slots for when they are used) so that interference is reduced or minimized. The protocols should include those for identifying which vehicle does what and when and how.

In addition to providing vehicle to vehicle warning alarms, further alarms may be provided within each vehicle using respective vehicle to user interfaces 136 of the subject vehicles. The vehicle/user interfaces 136 may include sound emitting devices, warning lights, vibration producing devices and/or warning displays by way of which a vehicle driver or other vehicle user may be made aware of changed conditions that might warrant manual take over of at least part of vehicle control, including that of steering the vehicle. An example of a vehicle/user interface will be described below with reference to FIG. 4.

The on board data processors (and optional databases) 135 of the respective vehicles may be configured to receive input signals from the onboard sensors 132 and/or by way of communications 131 from offboard sensors (e.g., 111a) and/or from other sources (e.g., HQ 150) and to output control signals including those to automated vehicle controls 137 where the latter include controls for providing automatic steering, automatic braking or acceleration and automatic transmission shifts. The automated vehicle steering capability may be used to provide automated maintenance of an assigned lane offset amount, for example by way of the below described method of FIG. 3.

Although not individually shown, the road adjacent and/or remote control centers (e.g., HQ 150) may each include appropriate communication means, sensors, data processors and databases for keeping track of and controlling lane shift assignments in respective roadway segments and/or for respective clusters of vehicles (e.g., rat packs). The control center sensors and/or communicators may include those for acquiring current and predicted weather conditions (e.g., wind speed, precipitation, snow or ice conditions) and for acquiring current and predicted traffic conditions (e.g., average traffic speed, average traffic density, accidents, load weights). Of the control center databases may include records for respective roadway segments that provide preferred lane shift amounts (and directions) based on at least one of time, current or predicted traffic conditions and current or predicted weather conditions. As mentioned above, different roadway segments may have respectively different structural aspects which call for different lane shift amounts and/or other traffic control requests/commands (e.g., speed) based on traffic conditions and/or weather conditions.

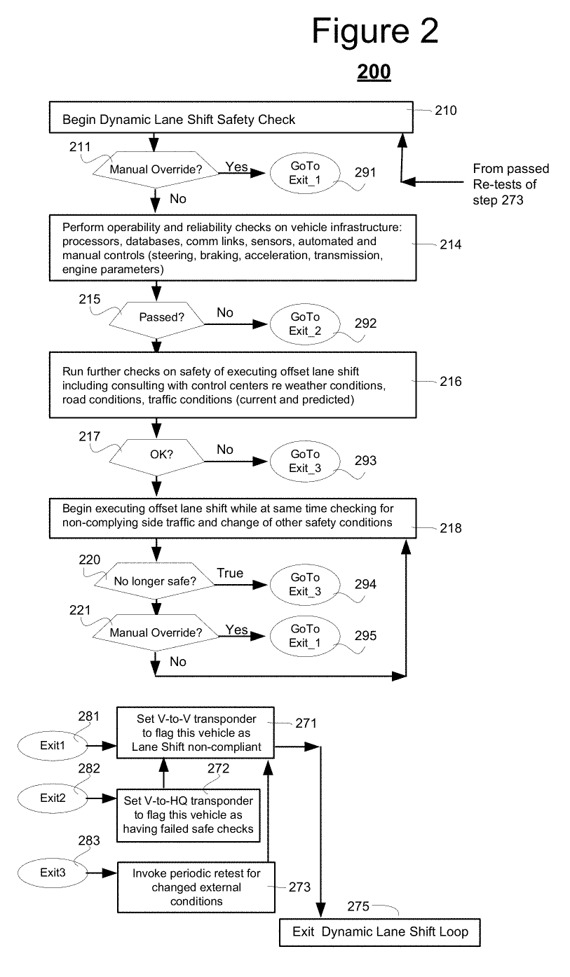

Referring to FIG. 2, a method 200 of entering into an automated lane shift mode will now be described. Before the automated lane shift mode is initiated, a safety check is undertaken beginning at step 210 for verifying that it is safe to enter the lane shift mode. At step 211 it is determined whether the vehicle driver or another user has activated a manual override of the automated lane shift mode. (See for example the manually depressible and red/green LED lit pushbutton 472c of below described FIG. 4.) If the answer to test 211 is Yes, control passes at step 291 to an exit point 281 denoted as Exit1. On the other hand, if the answer is No, further tests are automatically undertaken in step 214 including performing operability and reliability check on vehicle infrastructure portions such as its onboard processors and databases (e.g., 135), its onboard communication links (e.g., 131), its onboard sensors (e.g., 132) and its automated and manual control interfaces and control means (e.g., 136 and 137).

The operability and reliability checks of step 214 may include quality of service (QoS) checks on various one of communication and navigation services as well as data processing and artificial intelligence services provided by correspondingly configured data processors and databases. In other words, in one embodiment is not enough that the relevant systems are currently operable. Additionally, they need to be shown to be reliable at least for a predetermined stretch of future time (e.g., the next five minutes) before an automated lane shift mode is entered into. If the answer is no to test step 215, control passes at step 292 to an exit point 282 denoted as Exit2. On the other hand, if the answer is Yes, further tests are automatically undertaken in step 216 including machine-automated consulting with local and/or remote control centers (e.g., HQ 150) with respect to current or predicted weather conditions, current or predicted traffic conditions and/or current or predicted road conditions to thereby determine if it is safe to enter the automated lane shift mode at least for a predetermined stretch of time such as for the next 5 minutes. If the answer to test 217 is No, it is not safe then control passes at step 293 to an exit point 283 denoted as Exit3.

Referring to exit points 281-283, these are interrelated for reasons that will shortly become apparent. If Exit1 is taken, for example due to manual override of automated lane shift, then control passes to step 271 in which one or more indicators are activated to indicate that the subject vehicle (e.g., 120′ of FIG. 4) is in manual rather than automated lane shift mode. An example of such an indicator is a vehicle to vehicle transponder which is configured to signal nearby vehicles (e.g., those in immediately adjacent lanes and/or immediately in front or behind the subject vehicle) that the subject vehicle (e.g., 120′) is in a lane shift noncompliant mode. The nearby other vehicles may then take appropriate countermeasures for maintaining predetermined margins of safety. One example of such a countermeasure is for the sideways and/or forward and behind vehicles to temporarily enter a lane centered mode. Once the noncompliant vehicle (e.g., 120′) is safely spaced apart from them, the remaining compliant vehicles may negotiate with one another to simultaneously reenter the automated lane shift mode.

If Exit2 is taken, for example due to the subject vehicle having failed its safety checks, then control passes to step 272 in which one or more indicators are activated to indicate that the subject vehicle (e.g., 120′) has been detected as having operability and/or reliability problems. These indications may be transmitted to nearby other vehicles and/or two local or remote control centers. Block 272 provides the example where a vehicle to headquarters transponder is switched into a mode where it periodically informs HQ of its operability and/or reliability failures and details regarding these. The data processors and/or databases at the informed control center (e.g., HQ 150) may then take appropriate safety measures including for example, commanding other vehicles in the area to switch into manual steering mode or into lane-centered mode until the vehicle with the operability and/or reliability problems is safely away from the corresponding cluster or clusters of vehicles. In general, if there are operability and/or reliability problems, the driver or other user of the faulty vehicle (e.g., 120′) is warned of the problems and asked to take manual control at least of the steering of the vehicle. Depending on the severity of the problems, the driver/other user may be automatically asked to steer the vehicle off the road or to a nearby service center. The vehicle to vehicle lane shift noncompliant indication is additionally set at step 271 and then exit is taken by way of step 275 with the subject be vehicle being in a manual steering mode.

If Exit3 is taken, for example due to the subject vehicle approaching an area of treacherous terrain and/or severe weather conditions, then control passes to step 272 in which periodic retesting is invoked to see if the lane shift mode preventing conditions have lapsed and at the same time the vehicle to vehicle lane shift noncompliant indication is additionally set at step 271 and then exit is taken by way of step 275 with the subject be vehicle being in a manual steering mode. The invoked periodic retests of changed external conditions (initiated in step 273) may provide a return to step 210 (begin dynamic Lane shift safety check) once of the preventative external conditions are no longer present.

Referring to FIG. 3, a method 300 for maintaining a requested/commanded lane shift mode is now described. An automatically repeated loop is initiated at step 310, preferably after the safety checks of method 200 have been performed. At step 311, the loop again tests to see whether manual override has been initiated and if so, control is passed to Exit1 by way of process point 391. At step 312, the loop again tests to see whether other changed conditions exist and if so, control is passed to step 220 of method 200 by way of process point 392. These other changed conditions may include upcoming severe weather, upcoming treacherous road terrain, accidents up ahead on the road, change in operability or reliability of navigation or other services.

At step 314 the loop (started at 310) obtains current steering control parameters of the vehicle. These may include current amplification and/or damping factors to be applied to received steering commands. The loop also obtains a current shifted lane assignment for the subject vehicle. This may include redirection and optionally an index for or the actual amount of shift desired. The loop yet additionally obtains current lane bands data or equivalent. This indicates which lane bands the vehicle's tires currently occupy and/or what the current amount of offset from lane center the vehicle currently occupies.

If at test step 315 it is determined that the vehicle is compliant with the currently requested/commanded lane bands and/or the currently requested/commanded offset from lane center (and/or the currently requested offset from the lane delimiting stripe) then control is returned to the head of the loop 310.

On the other hand, if there is a mismatch (a No response to test 315) then control passes to step 316 in which a determination is made as to the amount and direction of mismatch between the currently occupied lane bands and the currently assigned lane offset. Then in step 318 a temporary alteration to the steering control parameters is made so as to cause the vehicle to jog slightly either to the left or right so as to correct for the error found in step 316 and thereby bring the vehicle back into matching lane position corresponding to the currently assigned lane shift amount. Next at step 320 the steering control parameters are returned to their original settings so that the vehicle continues on its assigned course but while occupying the currently assigned lane bands (e.g., 121, 122).

Control is then passed back to the top of loop point 310. Also for the case of test step 315, if it is determined that Yes there is a match, then control is passed back to the top of loop point 310 thereby bypassing the temporary jog over adjustments of steps 316-320.

Referring to FIG. 4, shown is an example 400 of a user/vehicle interface that includes accommodations for automated lane shift. The drawing shows a view through a front windshield of vehicle 120′ of a roadway 110′ ahead and road adjacent electronic signage 118′ indicating a request or command from a corresponding control center (e.g., HQ 150 not shown) for traffic in this segment of roadway and at this time to maintain a predetermined offset to the right from the centers of their respective lanes.

Below a dashboard 123′ of the exemplary vehicle 120′, a number of user interface devices are provided for informing or alerting a vehicle driver or other user thereof (e.g., where latter may be for the case of a fully automated vehicle) of upcoming or immediately requested/commanded lane change assignments or of the current lane change assignment and allowing the driver/user to override the automatically maintained lane assignment when needed (e.g., during an emergency).

A first of the interface devices 410 is positioned directly in front of the driver/user and provides a visual indication of current interface conditions. In one embodiment, a soft green glow is used to indicate that all systems are in nominal condition. Situation indicating text such as “ALL OK” may be displayed in visual indicator 410 when driver/user attention to other interface devices is not needed. On the other hand, when driver/user attention to at least another of the interface devices is desired, the visual indicator 410 might flash red and display an arrow pointing to the additional interface device (in this case device 450) calling for the user's attention. A magnified view of an exemplary such additional interface device 450 is shown at 450′. A display portion 460 of this interface displays a number of situational condition lines including a first one 451 identifying itself as being directed to an automated steering condition and further indicating in a green lit area 461 that automated steering is currently “ON”. A second situational condition line 452 identifies itself as being directed to a lane alignment function and further indicates in a green lit area 462 that an automatically maintained right offset (e.g., “a_RT”) is currently in effect. Yet another situational condition line 453 may identify itself as being directed to yet another function and in the illustrated example a white lit area 463 is provided indicating that this additional function is currently “OFF”.

A number of user-activatable buttons or knobs 470 are provided around the periphery of the display area 460. One such set 474 of pushbuttons allows the user to scroll up and down or to the top of the list of conditional situations as desired. Another pushbutton 471 allows the user to toggle between different automated steering modes including on, off and a hybrid. A lit LED at the center of pushbutton 471 provides differently colored indications for the current mode and may flash when attention thereto is desired. When automated steering is fully on the LED of pushbutton 471 glows green. When automated steering is fully off the LED of pushbutton 471 is turned off. In hybrid mode, the LED glows orange and indicates that both the user and the onboard data processing system are simultaneously controlling the steering wheel. In one embodiment the steering wheel includes pressure sensors for detecting if the driver/user wishes to override or add a slight adjustment to a currently maintained automatic steering mode. Amount of pressure and/or positioning of handgrips may be used to distinguish between full override or partial hybrid adjustment. In one embodiment, the electronic signage request 118′ (e.g., shift right) is purely visual and it is up to the driver/user to decide whether to implement it or not. In such a case, the driver/user may actuate the requested lane shift by either using the hybrid adjust aspect of the pressure sensitive steering wheel or, alternatively, the driver/user may actuate the requested lane shift mode by shifting a horizontally reciprocal pushbutton knob 472c to the right as indicated. Sliding knob 472c to center position 472b will instead activate an automated lane centered mode. Sliding knob 472c to the left position 472a will instead activate an automated lane offset to the left. The amount of offset may be predetermined based on any of a variety of parameters including the type of vehicle involved, current weather and road conditions, and current traffic conditions where the amount of offset is obtained from a database provided either in the vehicle or in a linked-to control center (e.g., HQ 150). If the user/driver pushes in the slidable pushbutton 472, that toggles the lane assignment mode (462) at least between on and off modes and an LED within the button 472 correspondingly switch his color, for example, from green to red or two off. Pushbutton 473 may operate in similar fashion. For the illustrated example where its other function 453 is off (463), the LED at the center of pushbutton 473 is off.

In addition to the on-dashboard interfaces, vehicle 120′ may include rear view mirror interfaces 490 wherein a magnified view of some of these is provided in cross-section at 490′. A rearview mirror surface may be provided at 495. A plurality of driver facing cameras and illuminators may be provided at left and right sides of the mirror surface, for example at 491 and 492. The driver facing cameras and illuminators may include infrared illuminators or scanners for keeping track of the driver and his eye gaze as well as optionally detecting hand gestures and/or face gestures made by the driver. The driver facing cameras may include infrared (IR) sensitive ones as well as three-dimensional depth determining ones for recognizing the driver and keeping track of where the driver is looking and/or detecting gestures made by the driver.

A front facing portion of the mirror assembly 490′ may be provided at 496. Behind front facing portion 496, various electronic and optical components may be provided including antennas for acquiring GPS signals, microwave signals and optical (e.g., IR) signals. A plurality of front facing cameras and illuminators may be provided at the left and right sides of the front facing surface for example at 493 and 494. The front facing cameras may be used for recognizing lane stripes and/or other lane-identifying indicia so as to determine where the vehicle is relative to its currently occupied lane. The front facing cameras may include infrared (IR) sensitive ones as well as three-dimensional depth determining ones for recognizing possible road hazards (e.g., potholes) in front of the vehicle. While not shown, the mirror assembly 490′ may further include sideways looking cameras and/or illuminators for recognizing other vehicles to the left and right of the subject vehicle 120′ and determining sideways separation between the vehicles.

The above description of user/vehicle interfaces 400/450/490 are merely exemplary and may be augmented with or substituted for by audio-based controls such as ones that speak to the driver/user and/or use of various audio tones to alert the driver/user of upcoming changes or changed conditions and which is receptive to driver/user audio commands and/or to driver user/hand gestures for switching between modes.

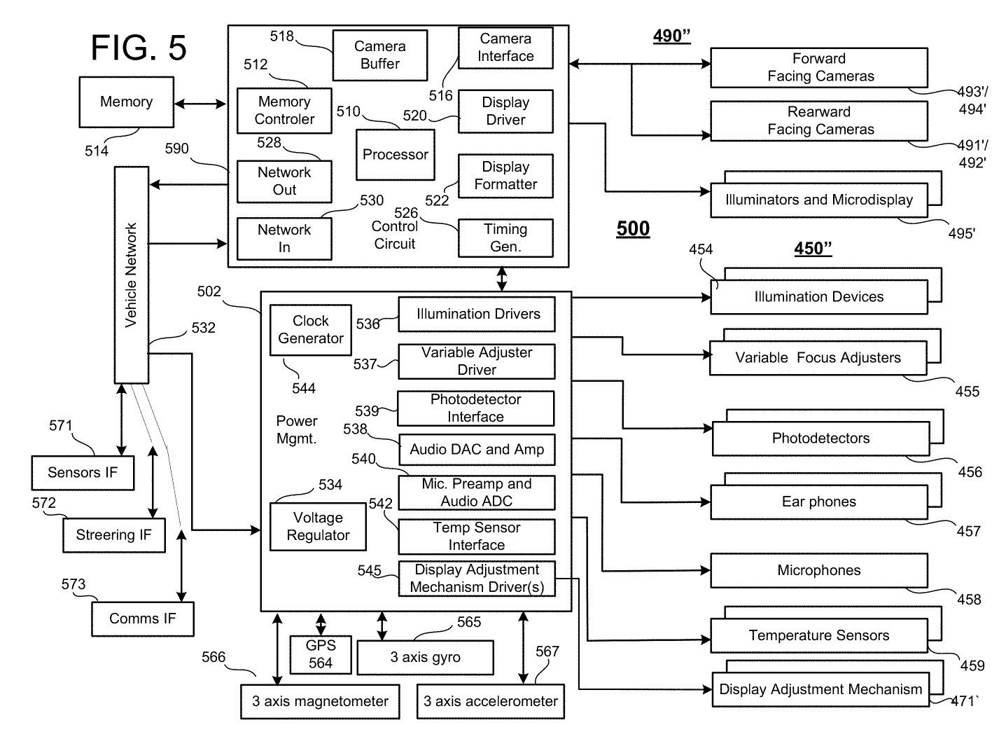

Referring to FIG. 5, shown is a block diagram of one embodiment 500 of hardware and software components of an in-vehicle data processing system as may be used with one or more embodiments. In this embodiment, a rear view mirror assembly 490″ includes forward facing and rearward facing cameras, 491′-494′ which are controlled by an images processing unit 590. Unit 590 includes a processing unit 510 configured for receiving analog and/or digital image signals from the various cameras, filtering the image signals and performing image recognition functions based on the received image signals. Software and hardware components which may be embodied in the processing unit 510 may also receive sensory information from other onboard sensors for aiding in its recognition of the vehicle interior and vehicle exterior physical configurations. The mirror assembly 490″ may include a microdisplay 495′ by way of which abbreviated messages can be displayed to the user. Additionally, the mirror assembly 490″ may include illuminators for illuminating the driver on its rear facing side and/or the roadway in front of it. While not shown, the vehicle headlight assemblies may include yet additional illuminators for illuminating the roadway in front, including in the IR band. Processor 510 is operatively coupled to a plurality of interface components which may include: a memory 514 and memory controller 512, a buffer 518 for storing camera images, an interface unit 516 for interfacing with the various different kinds of cameras, a display and illuminators driver 524 interfacing with the mirror assembly illuminators and micro display 495′; a display formatter 522 for controlling how messages will be displayed on the micro display; a display and vehicle network timing generator 526 for generating clocks used by the microdisplay and by vehicle network interface components 528 and 530. Components 528 and 530 interface with an in-vehicle network 532 which couples unit 592 other onboard data processing units of the vehicle.

An in-dashboard portion 450″ of the system may include its own illumination devices 454, variable focus adjusters 455 which aim focus of their illumination devices towards the driver/user; various photodetectors 456 configured to optically detect vehicle interior and exterior states; speakers and earphones 457 for providing audio output signals; microphones 458 for picking up audio input signals; temperature sensors 459 for providing for error correction based on temperature variation and further display adjustment and pushbutton detect mechanisms 471′.

In one embodiment, network connected unit 502 includes power management components such as a voltage regulator 534 and further clock generator 544. Unit 502 further includes additional illumination drivers 536, variable adjust drivers 537, photodetector interface 539, audio DACs and amplifiers 538, microphone preamplifiers and audio ADCs 540, temperature sensor interfaces 542, and display adjustment mechanism driver(s) 545. Voltage regulator 534 receives power from an onboard vehicle power system (not shown) and provides regulated power to the other components of the in-vehicle data processing system including appropriate digital logic driving voltages and analog driving voltages. In one embodiment, unit 502 also provides power and receives data back from various navigation components including a GPS unit 564, a three axis gyro unit 565, three axis magnetometer 566 and three axis accelerometer 567. In one embodiment, the unit 502 includes a recharging management module (not shown) which allows small on-board batteries (not shown, e.g. 3 VDC, 4.5 VDC) to be recharged so that the in-vehicle data processing system may continue to operate and at least provide wireless communication to nearby vehicles or to local or remote control centers even if the main power system of the vehicle becomes temporarily inoperable. Although not shown in FIG. 5, it is to be understood that the illustrated vehicle communications network 532 operatively coupled to various communication devices of the vehicle and various sensors of the vehicle (e.g., via communications interface 573) so as to provide for integrated control of vehicle communications, vehicle sensing subsystems (e.g., via sensors interface 571) and vehicle operational subsystems (e.g., via steering and other controls interface 572) including its automated steering, braking and acceleration components.

The example computer systems illustrated in the figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

What has been disclosed therefore includes a machine-implemented method of controlling vehicle positioning within a traffic lane occupied by a vehicle, where the method comprises: determining side boundaries or a longitudinal center of a traffic lane currently occupied by the vehicle; determining a currently requested or commanded offset from either one of the side boundaries or the longitudinal center of the traffic lane; determining if the vehicle is currently complying with the requested or commanded offset; and if the vehicle is not currently complying with the offset, adjusting a steering control of the vehicle to thereby bring the vehicle into compliance with the currently requested or commanded offset. The method may include a step prior to adjusting the steering control of the vehicle, of determining whether it is currently safe to comply with the currently requested or commanded offset. The method may include a step of determining whether a driver or user of the vehicle is attempting to take over manual control of the vehicle steering. The method may include determining whether a neighboring vehicle in an adjacent lane is too close to the present vehicle to safely allow the present vehicle to come into compliance with the currently requested or commanded offset. The method may include determining whether a neighboring vehicle in an adjacent lane is currently in compliance with a respective requested or commanded offset issued to that neighboring vehicle or if a that neighboring vehicle is able to come into compliance with its respective offset at substantially the same time that the present vehicle comes into compliance with its currently requested or commanded offset. The method may include determining whether onboard systems of the present vehicle that are to be used for complying with the currently requested or commanded offset are operable and reliable upon at least for a predetermined stretch of time. The method may include a step wherein if the determining of whether it is currently safe to comply determines that it is not safe, not performing the adjusting of the steering control and activating a noncompliance indicator which indicates that the present vehicle is not in compliance. The method may include actuating a vehicle to vehicle transponder that signals adjacent vehicles of the noncompliance state of the present vehicle. The method may include a step wherein if the determining of whether it is currently safe to comply determines that it is not safe, actuating a vehicle to user interface that signals a driver or user of the present vehicle of the noncompliance state of the present vehicle.

What has been disclosed therefore includes a road vehicle that comprises: one or more sensors configured to respectively sense at least one of location and distance for use in determining side boundaries or a longitudinal center of a traffic lane currently occupied by the vehicle or distance of a respective portion of the vehicle from at least one of the side boundaries and the longitudinal center; an offset signal receiver configured to receive an offset requesting or commanding signal for thereby determining a currently requested or commanded offset from either one of the side boundaries or the longitudinal center of the traffic lane; a vehicle offset compliance determining unit configured for automatically determining if the vehicle is currently complying with the requested or commanded offset; and an automatically controllable vehicle steering system operatively coupled to the vehicle offset compliance determining unit and configured such that, if the vehicle is not currently complying with the requested or commanded offset, the vehicle steering system is operable to automatically bring the vehicle into compliance with the currently requested or commanded offset. The vehicle may include one or more communication systems including at least one configured to allow the present road vehicle to communicate with other road occupying vehicles to thereby alert the other road occupying vehicles of noncompliance by the present vehicle if the present vehicle is not currently complying with the requested or commanded offset. The vehicle may be such that at least one of the communication systems is configured to receive from other road occupying vehicles, their respective alert signals indicating noncompliance by the other vehicles with their respectively requested or commanded offsets. The vehicle may be such that at least one of the communication systems is configured to receive from a control center, a requested or commanded amount and/or direct action of offset or an indication thereof. The vehicle may be such that at least one of the communication systems is configured to receive from road adjacent sensors or from road embedded sensors signals indicative of current road conditions.

What has been disclosed therefore includes a data processing system configured to automatically control positioning of a vehicle within a lane occupied by the vehicle, where the system comprises a sensor interface operatively coupled to one or more sensors including sensors configured to respectively sense at least one of location and distance for use in determining location of or distance of a vehicle portion from side boundaries or a longitudinal center of a traffic lane currently occupied by the vehicle; a communications interface operatively coupled to one or more signal receivers/transmitters including to an offset signal receiver configured for receiving a signal that indicates or determines a currently requested or commanded offset from at least one of the side boundaries and the longitudinal center of the traffic lane; a navigations interface operatively coupled to one or more navigation units including a vehicle position locator configured for sensing vehicle location and thus determining if the vehicle is currently complying with the requested or commanded offset; and a vehicle controls interface operatively coupled to one or more vehicle control units including an automatically controllable vehicle steering system configured such that, if the vehicle is not currently complying with the offset, the vehicle steering system can be actuated to bring the vehicle into compliance with the currently requested or commanded offset. The system may be such that at least one of the coupled to receivers/transmitters is configured to receive from other road occupying vehicles, their respective alert signals indicating noncompliance by the other vehicles with their respectively requested or commanded offsets. The system may be such that at least one of the coupled to receivers/transmitters is configured to receive from a control center, a requested or commanded amount and/or direct action of offset or an indication thereof. The system may be such that at least one of the coupled to receivers/transmitters is configured to receive from road adjacent sensors or from road embedded sensors signals indicative of current road conditions. The system may include a vehicle to user interfacing interface operatively coupled to one or more vehicle to user interfacing units including an interfacing unit configured to indicate whether or not the vehicle is currently in an automated lane shift mode. The system may be such that the configured interfacing unit is further configured to indicate whether or not the vehicle is currently in an automated steering mode.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A machine-implemented method of controlling vehicle positioning within a traffic lane occupied by a vehicle, the method comprising:
determining side boundaries or a longitudinal center of a traffic lane currently occupied by the vehicle;
determining a currently requested or commanded offset from either one of the side boundaries or the longitudinal center of the traffic lane;
determining if the vehicle is currently at least in substantial compliance with the requested or commanded offset; and
if the vehicle is not currently at least substantially complying with the offset, adjusting a steering control of the vehicle to thereby bring the vehicle into compliance with the currently requested or commanded offset.

2. The method of claim 1 and further comprising:
prior to adjusting the steering control of the vehicle, determining whether it is currently safe to comply with the currently requested or commanded offset.

3. The method of claim 2 wherein said determining of whether it is currently safe to comply includes determining whether a driver or user of the vehicle is attempting to take over manual control of the vehicle steering.

4. The method of claim 2 wherein said determining of whether it is currently safe to comply includes determining whether a neighboring vehicle in an adjacent lane is too close to the present vehicle to safely allow the present vehicle to come into compliance with the currently requested or commanded offset.

5. The method of claim 2 wherein said determining of whether it is currently safe to comply includes determining whether a neighboring vehicle in an adjacent lane is currently in compliance with a respective requested or commanded offset issued to that neighboring vehicle or if a that neighboring vehicle is able to come into compliance with its respective offset at substantially the same time that the present vehicle comes into compliance with its currently requested or commanded offset.

6. The method of claim 2 wherein said determining of whether it is currently safe to comply includes determining whether onboard systems of the present vehicle that are to be used for complying with the currently requested or commanded offset are operable and reliable upon at least for a predetermined stretch of time.

7. The method of claim 2 wherein if said determining of whether it is currently safe to comply determines that it is not safe, not performing said adjusting of the steering control and activating a noncompliance indicator which indicates that the present vehicle is not in compliance.

8. The method of claim 7 wherein said noncompliance indicator includes a vehicle to vehicle transponder that signals adjacent vehicles of the noncompliance state of the present vehicle.

9. The method of claim 7 wherein said noncompliance indicator includes a vehicle to user interface that signals a driver or user of the present vehicle of the noncompliance state of the present vehicle.

10. A road vehicle comprising:
one or more sensors configured to respectively sense at least one of location and distance for use in determining side boundaries or a longitudinal center of a traffic lane currently occupied by the vehicle or distance of a respective portion of the vehicle from at least one of the side boundaries and the longitudinal center;
an offset signal receiver configured to receive an offset requesting or commanding signal for thereby determining a currently requested or commanded offset from either one of the side boundaries or the longitudinal center of the traffic lane;
a vehicle offset compliance determining unit configured for automatically determining if the vehicle is currently substantially in compliance with the requested or commanded offset; and
an automatically controllable vehicle steering system operatively coupled to the vehicle offset compliance determining unit and configured such that, if the vehicle is not currently substantially complying with the requested or commanded offset, the vehicle steering system is operable to automatically bring the vehicle into compliance with the currently requested or commanded offset.

11. The vehicle of claim 10 and further comprising:
one or more communication systems including at least one configured to allow the present road vehicle to communicate with other road occupying vehicles to thereby alert the other road occupying vehicles of noncompliance by the present vehicle if the present vehicle is not currently complying with the requested or commanded offset.

12. The vehicle of claim 11 wherein at least one of the communication systems is configured to receive from other road occupying vehicles, their respective alert signals indicating noncompliance by the other vehicles with their respectively requested or commanded offsets.

13. The vehicle of claim 11 wherein at least one of the communication systems is configured to receive from a control center, a requested or commanded amount and/or direct action of offset or an indication thereof.

14. The vehicle of claim 11 wherein at least one of the communication systems is configured to receive from road adjacent sensors or from road embedded sensors signals indicative of current road conditions.

15. A data processing system configured to automatically control positioning of a vehicle within a lane occupied by the vehicle, the system comprising:
a sensor interface operatively coupled to one or more sensors including sensors configured to respectively sense at least one of location and distance for use in determining location of or distance of a vehicle portion from side boundaries or a longitudinal center of a traffic lane currently occupied by the vehicle;
a communications interface operatively coupled to one or more signal receivers/transmitters including to an offset signal receiver configured for receiving a signal that indicates or determines a currently requested or commanded offset from at least one of the side boundaries and the longitudinal center of the traffic lane;
a navigations interface operatively coupled to one or more navigation units including a vehicle position locator configured for sensing vehicle location and thus determining if the vehicle is currently at least substantially complying with the requested or commanded offset; and
a vehicle controls interface operatively coupled to one or more vehicle control units including an automatically controllable vehicle steering system configured such that, if the vehicle is not currently complying with the offset, the vehicle steering system can be actuated to bring the vehicle into compliance with the currently requested or commanded offset.

16. The data processing system of claim 15 wherein at least one of the coupled to receivers/transmitters is configured to receive from other road occupying vehicles, their respective alert signals indicating noncompliance by the other vehicles with their respectively requested or commanded offsets.

17. The data processing system of claim 15 wherein at least one of the coupled to receivers/transmitters is configured to receive from a control center, a requested or commanded amount and/or direct action of offset or an indication thereof.

18. The data processing system of claim 15 wherein at least one of the coupled to receivers/transmitters is configured to receive from road adjacent sensors or from road embedded sensors signals indicative of current road conditions.

19. The data processing system of claim 15 and further comprising:
a vehicle to user interfacing interface operatively coupled to one or more vehicle to user interfacing units including an interfacing unit configured to indicate whether or not the vehicle is currently in an automated lane shift mode.

20. The data processing system of claim 19 wherein the configured interfacing unit is further configured to indicate whether or not the vehicle is currently in an automated steering mode.
